(19) United States
(12) Patent Application Publication
(10) Pub. No.: US 2017/0343191 A1
(43) Pub. Date: Nov. 30, 2017

(54) DOCK LIGHT WITH SELF-CORRECTING BEAM

(71) Applicant: DL Manufacturing, North Syracuse, NY (US)

(72) Inventor: Donald L. Metz, Kirkville, NY (US)

(73) Assignee: DL Manufacturing, North Syracuse, NY (US)

(21) Appl. No.: 15/609,454

(22) Filed: May 31, 2017

Related U.S. Application Data
(60) Provisional application No. 62/343,159, filed on May 31, 2016.

(51) Int. Cl. F21V 14/08; F21V 17/02; F21V 13/04; F21V 7/08; F21V 5/04; F21V 11/00; F21V 21/32; F21V 29/77; F21Y 2115/10

(52) U.S. Cl. CPC F21V 14/08; F21V 21/32; F21V 17/02; F21V 13/04; F21V 29/77; F21V 7/08; F21V 5/048; F21V 11/00; F21Y 2115/10

(57) ABSTRACT

Disclosed is a dock light assembly for illuminating a trailer interior. The dock light assembly may include a cylindrical housing having an illumination source therein, and an optical lens secured to an end of the housing. The optical lens may be configured to provide focused illumination to the trailer interior. A rotationally self-correcting screen device may be positioned between the illumination source and the optical lens. The screen device may be configured to absorb a portion of the focused illumination such that illumination to an upper portion of the trailer interior is reduced. The rotationally self-correcting screen device remains in a horizontal orientation even if the housing is rotated. One benefit of the disclosed dock light assembly is that forklift operators working in the trailer interior are shielded from high intensity light, even though the lower portion of the trailer interior remains brightly lit.

### CROSS REFERENCE TO RELATED APPLICATION

Reference is made to and this application claims priority from and the benefit of U.S. Provisional Application Ser. No. 62/343,159, filed May 31, 2016, entitled “DOCK LIGHT WITH SELF-CORRECTING BEAM”, which application is incorporated herein in its entirety by reference.

### BACKGROUND OF THE INVENTION

Dock lights are used on the loading platform of a warehouse or the like for the purpose of illuminating the interior of a truck backed up to the loading platform. Typically, the light is mounted adjacent to the loading dock of the warehouse undercover to protect the dock light from the elements when not in use. One such dock light is disclosed in commonly owned U.S. Pat. No. 5,709,458 and U.S. Pat. No. 7,686,476, incorporated herein by reference in their entirety, and includes a base portion mounted adjacent the overhead doorway, and a flexible, hollow, self-supporting tube connected to the base. The tube is comprised of a spiral metallic assembly interfitted to provide a self-supporting flexible member. The dock light may include a high intensity halogen bulb, or an array of LED bulbs. In either case, the dock light also includes a fan for drawing air in through louvers in the base portion, with the airflow then passing through the flexible tube to the lamp assembly for purposes of cooling the lamp assembly.

Although the aforementioned dock light assembly has proven useful and is well-received in the industry, there exists a desire for even brighter illumination within the trailer. However, the high intensity halogen bulbs or LED arrays currently being used are very bright. Further increases in light intensity may not be safe for forklift operators who, when backing out of or otherwise exiting the trailer, are facing directly into the high intensity light.

### SUMMARY OF THE INVENTION

Embodiments of the present invention disclose a dock light assembly for illuminating a trailer interior. The dock light assembly includes a main housing comprising a forward end and an opposing rear end, and a lens holder coupled to the forward end of the housing. An optical lens is secured by the lens holder and is configured to provide focused illumination to the trailer interior. The dock light assembly further includes an electronics package including an illumination source secured to a rear portion of the main housing. The dock light assembly further includes a rotationally self-correcting screen device positioned between the illumination source and the optical lens. The screen device is configured to absorb a portion of the focused illumination such that illumination to an upper portion of the trailer interior is reduced.

In accordance with one aspect of the disclosure, the screen device includes a dense, thin plate having an approximate semi-circular shape, and the rotationally self-correcting feature is characterized by the plate being free to rotate about a center post secured to the main housing such that rotational movement of the housing rotates the post but not the plate.

In one embodiment, the optical lens is plano-convex.

In accordance with another aspect of the disclosure, the dock light assembly further includes a heat sink in thermal contact with the electronics package. The heat sink is configured to dissipate heat generated from the light source during operation.

In one embodiment, the heat sink includes a plurality of thin, radially-extending fins sized for an interference fit within the main housing.

In accordance with yet another aspect of the disclosure, the screen device includes a sealed volume defining a reservoir, and the rotationally self-correcting feature is characterized by the reservoir being filled to a horizontal level with an opaque fluid, such that rotational movement of the housing does not alter the horizontal level of the fluid.

In one embodiment, the screen device comprises a ring having a sealed reservoir therein. The ring comprises a forward face and a rear face, each hermetically sealed with an optically clear material.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 schematically illustrates a prior art dock light assembly;

FIG. 2 depicts a side perspective view of a dock light assembly in accordance with one embodiment of the present invention;

FIG. 3 schematically depicts a side plan view of a dock light assembly having a plano-convex lens;

FIG. 4 depicts a side plan view of the dock light assembly shown in FIG. 3;

FIG. 5 schematically depicts a side plan view of a dock light assembly having a plano-convex lens and a screen device in accordance with one embodiment of the present invention;

FIG. 6 depicts a side plan view of the dock light assembly shown in FIG. 5;

FIG. 7 depicts an opposite side perspective view of the dock light assembly shown in FIG. 2;

FIG. 8 schematically depicts a side plan view of a dock light assembly with plano-convex lens and a screen device in accordance with another embodiment of the present invention; and

FIG. 9 depicts a front plan view of the screen device shown in FIG. 8.

### DETAILED DESCRIPTION OF THE INVENTION

The present invention is directed to a dock light and more specifically to a high intensity light which is adapted to be mounted inside a warehouse adjacent a door on the loading platform, which is adapted to extend in an adjustable manner outwardly of the warehouse to shine into the interior of a truck backed up to the loading platform. The dock light is designed with a screen device to shade an upper portion of the beam field so as to protect forklift operators from the high intensity light. Because the light assembly is affixed to a flexible tube which allows rotational movement, and the screen device within the lamp assembly should remain substantially horizontal, the screen device is designed to auto-correct for rotational movement.

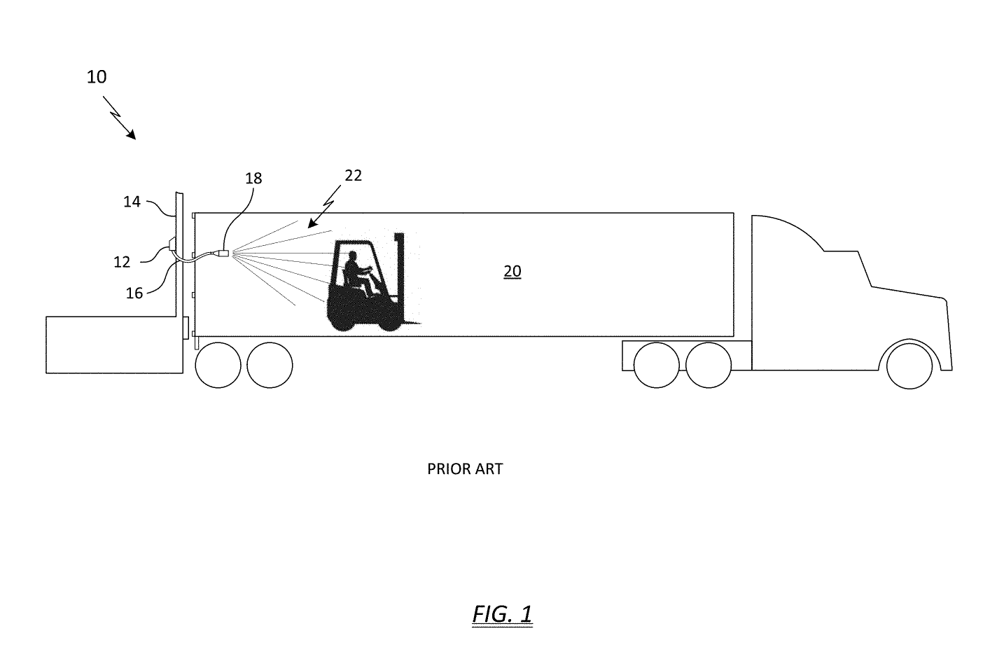

FIG. 1 depicts a prior art dock light assembly 10 having a high intensity halogen bulb. The dock light assembly 10 includes a base portion 12 mounted to an interior wall 14 of a loading dock, a hollow, flexible tube 16 connected to the base portion 12, and a lamp assembly 18 having a halogen bulb. In operation, loading dock personnel adjust the flexible tube 16 to properly illuminate the trailer interior 20. Although the lamp assembly 18 provides adequate illumination, the light field 22 is omni-directional, meaning light beams are emitted equally in all directions. Thus, when a forklift operator turns around to back out of the trailer interior 20, the operator faces directly into the light beam.

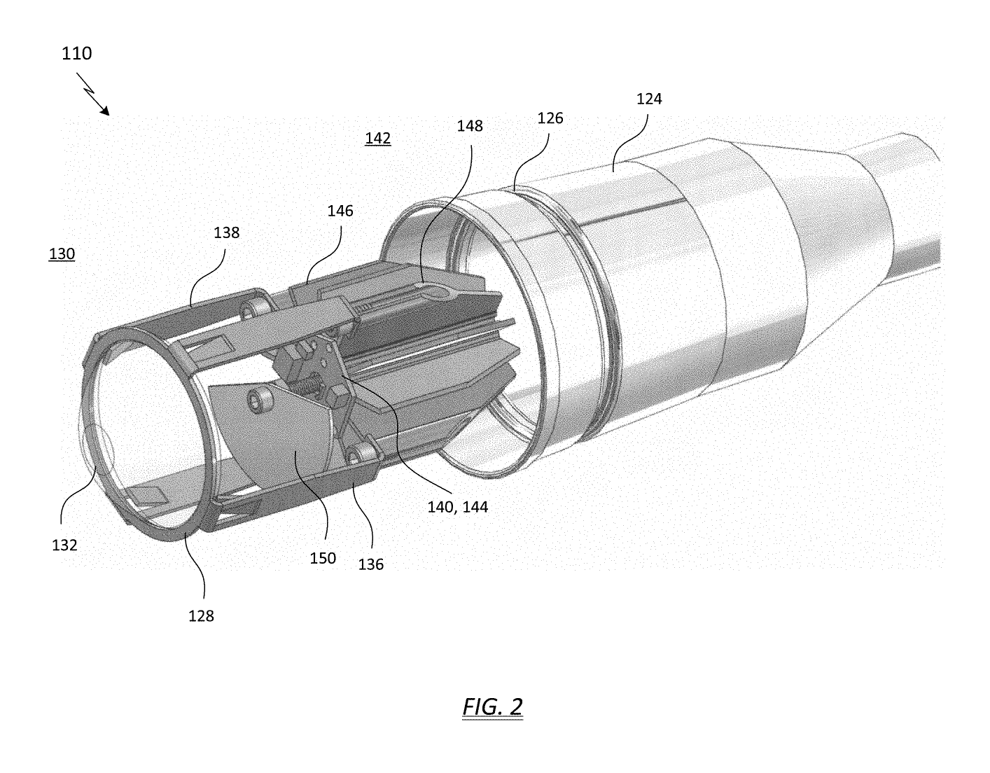

Referring to FIG. 2, wherein like numerals indicate like elements in FIG. 1, a dock light assembly 110 is shown according to one embodiment of the invention. The dock light assembly 110 includes a main housing 124, which may be a thin-walled cylinder and formed of a thermally conductive material, such as aluminum. The housing 124 may include a locking feature 126 to secure the internal components of the lamp assembly. In one example, the outer surface of the main housing 124 defines an annular groove 126, which may be formed into the thin-walled housing. The indented groove 126 on the outer surface forms a corresponding annular raised ridge on the inner surface of the housing 124, which may be utilized to secure internal components.

The dock light assembly 110 further includes a ring-shaped lens holder 128 on a forward end 130 of the assembly, the forward end being defined as the beam-emitting end. The lens holder 128 secures an optical lens 132 which, in the illustrated embodiment, is a plano-convex lens having the flat side oriented towards the light source. In this configuration, light emitted from a source within the housing 124 converges in front of the lens at the lens focal point 134 (FIG. 3), then diverges to illuminate the trailer, as shown in FIG. 3.

Other types of optical lens are anticipated within the scope of the present invention. For example, the optical lens may be a projector type, having a polyellipsoidal reflector and condenser lens. This listing is exemplary in nature and not intended to be limiting.

Structural support for the lens holder 128 may be provided by a plurality of stiffener legs 136 secured to the outer diameter of the lens holder 128. The stiffener legs 136 may be integral with the lens holder 128 or fasten thereto. The stiffener legs 136 may define a capture feature 138 to engage the locking feature 126 on the housing 124. In one example, the outer diameter of the stiffener legs 136 may be sized for a slight interference fit with the annular raised ridge 126 on the inner surface of the housing 124. The axial length of the legs 136 may be dictated by optical considerations. For example, a particular combination of light source and lens may require a specific axial separation or distance between the two to properly converge the light field 122 at a focal point 134 that results in a desirable illumination in the trailer interior 120.

An electronics package 140 may be disposed within the opposing rear end 142 of the housing 124. The electronics package 140 may comprise a printed circuit board, and may be secured to the stiffener legs 136 to complete a frame-like structure. The electronics package 140 may include, as illustrated, an LED array 144 to provide the illumination source. In alternate embodiments, the electronics package 140 may include a halogen bulb, for example.

A heat sink 146 may be in thermal contact with the electronics package 140 to dissipate the heat generated from the light source during operation. In one embodiment, the heat sink 146 comprises a plurality of thin, radially-extending metallic fins. In one example, the heat sink fins 146 are sized for a slight interference fit within the housing 124. In this manner, heat dissipated off the fins may be conducted into the housing 124. In one embodiment, the forward end 130 of the heat sink 146 defines a planar surface to which the electronics package 140 may be directly mounted. In another embodiment, some of the outer edges of the fins define an aperture 148 suitable for mounting provisions to secure the stiffener legs 136 with bolts, for example.

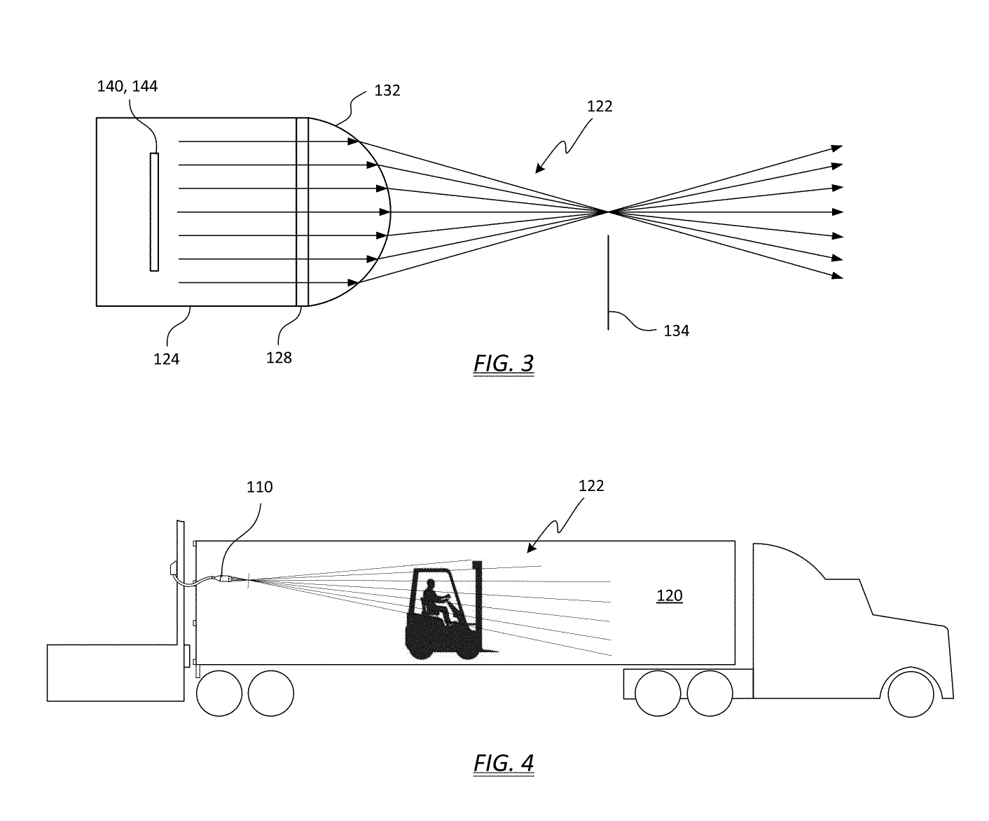

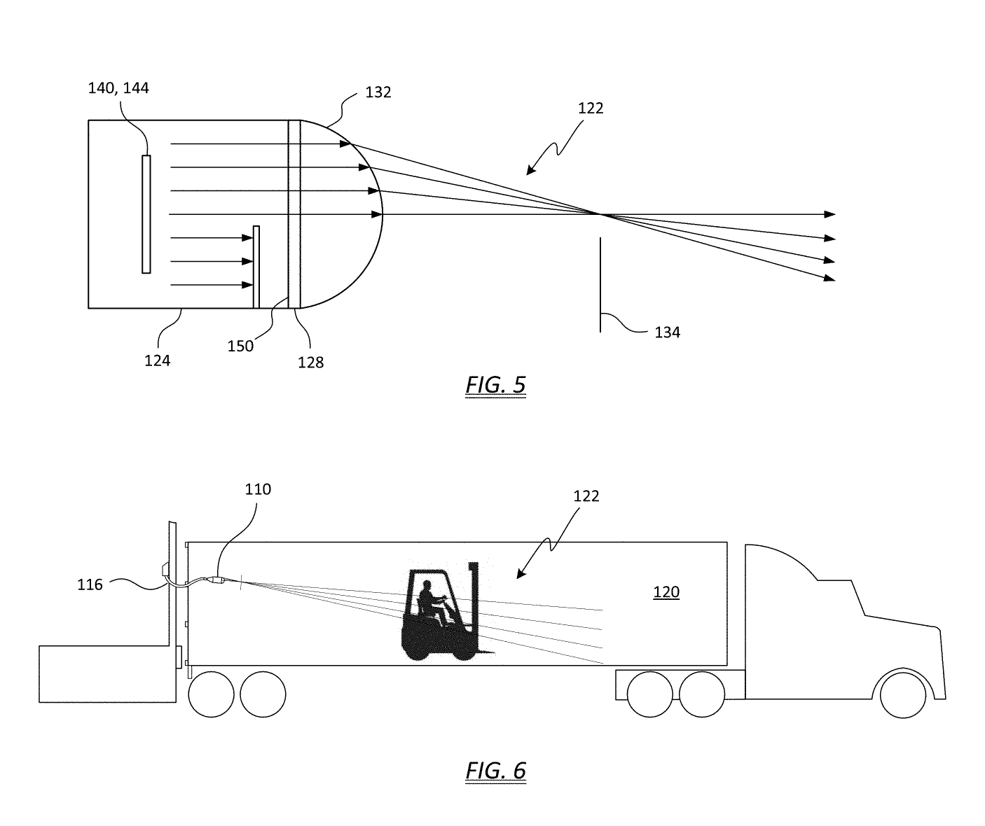

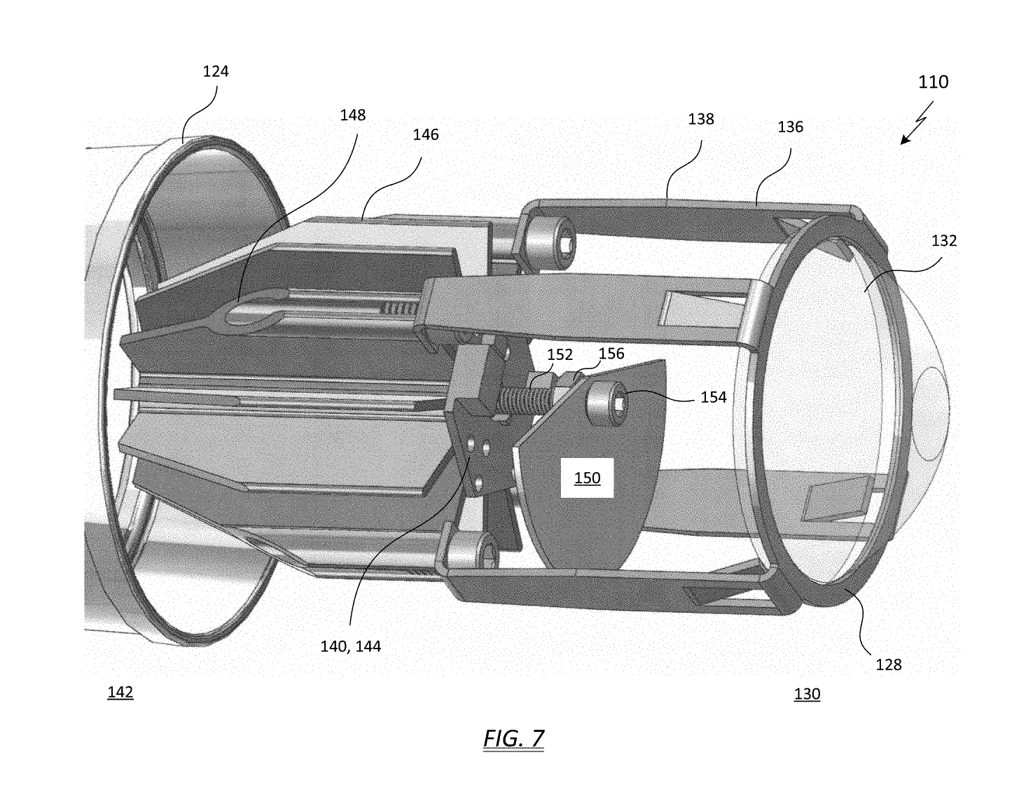

As illustrated in FIGS. 3-4, the LED array 144 emits a light field 122 that passes through the plano-convex optical lens 132, converges at the focal point 134, and diverges therebeyond to illuminate the trailer interior 120. Although the configuration provides a better focused illumination, it does not necessarily solve the problem of the beam shining in the eyes of a forklift operator. Referring back to FIG. 2, in one embodiment of the invention the problem is solved by placing a screen device 150 in the dock light assembly 110. The screen device 150 is placed within the illumination path between the light source and the optical lens 132 to shade an upper portion of the beam field 122 so as to protect forklift operator's eyes from the high intensity light. As illustrated in FIGS. 5-6, blocking the bottom portion of the illumination path has the effect of shading the upper portion of the trailer interior 120.

The flexible tube portion 116 of the dock light assembly 110 permits an operator to adjust the lamp assembly over a fairly wide vertical and horizontal range. The flexible nature of the tube also permits the operator to rotate the lamp which, under prior art circumstances, had no deleterious effect on the light beam since the housing is round and the beam was omni-directional. However, a dock light assembly 110 having a screen device 150 secured to the housing 124 (as illustrated in FIG. 5) could present a problem: the horizontal upper surface of the plate 150 would rotate with the housing 124, and thus rotate the shaded portion projected into the trailer, which could negate the benefits of the screen device.

To solve this problem, a screen device 150 is disclosed that self-corrects for rotational movement. In the embodiment shown in FIG. 2, the screen device 150 is a dense, thin plate having an approximate semi-circular shape. In one example, the plate is formed of steel. The upper portion of the plate may be horizontal (or slightly angled within 15°) to provide a line of demarcation in the shaded region projected into the trailer interior 120. The screen device 150 may include a thru-hole of sufficient diameter to allow a generous clearance for a post 152 or threaded rod to pass through. In the illustrated embodiment, a threaded bolt 152 is used. The thru-hole in the plate should be located near the top horizontal surface.

To assemble the rotationally self-correcting screen device 150, the threaded bolt 152 is passed through the hole in the plate, and the plate is pushed along the shank up to the bolt head 154. A nut 156 is next run up the threaded bolt 152, and stopped several thread turns away from engaging the plate. In this manner, the plate may rotate freely about the bolt, but it is captured axially between the bolt head 154 and nut 156. The bolt 152 may next be threaded into a corresponding tapped hole in the heat sink 146, for example, along the centerline of the housing 124 and optical lens 132.

The dense nature of the screen plate 150, coupled with its center of gravity being well below the bolt hole, and its freedom to rotate, permits the force of gravity to keep the plate in a horizontal orientation. Any rotation of the main housing 124 will have no effect on the screen plate 150. Although the bolt 152 will rotate with the housing 124, the plate self-corrects to remain horizontal.

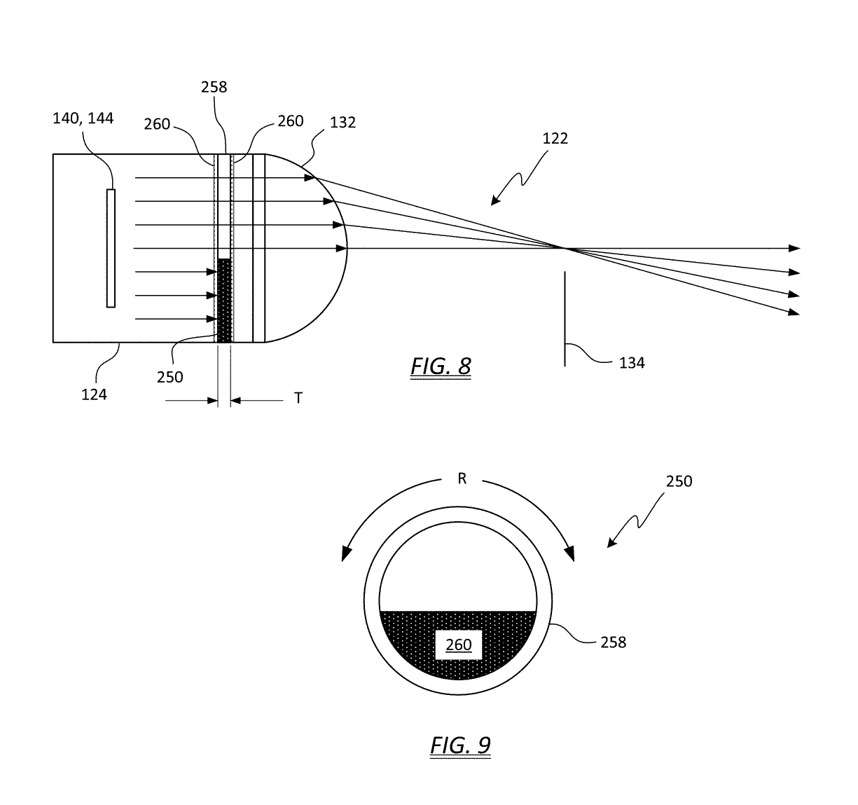

Turning now to FIGS. 8-9, in another embodiment of the invention a screen device 250 may comprise a sealed volume of opaque fluid, such as ink. In one embodiment, the screen device 250 may include a thin ring 258 approximately ⅛″ to ¼″ thick, having an outer diameter approximately equal to that of the lens holder or stiffener legs, and an inner diameter no less than the optical lens 232. The forward and rear faces of the ring 258 may be hermetically sealed with an optically clear material 260 such as glass or acrylic, thereby providing an internal volume within the thickness (T) of the ring 258. An opaque fluid 262 may be injected into the internal volume, to a height sufficient to provide the desired screen or shading effect. Any rotation of the main housing 224, indicated by arrows in FIG. 9, will have no effect on the function of the screen device 250 because the opaque fluid 262 self-corrects to remain horizontal. In one example, the opaque fluid 262 may comprise a dark fluid to absorb virtually all light passing through it. In another example, the opaque fluid 262 may comprise a mixture having a dark fluid in suspension with a lighter fluid. The ratio of dark fluid to light fluid may be varied to achieve a “dimming effect” within the trailer interior, rather than a complete blockage of light. In yet another example, the opaque fluid 262 may comprise a mixture having a graduated opacity, in which the light-absorbing properties vary from top to bottom, side-to-side, or a combination of the two. A fluid 262 having a graduated opacity may provide illumination in the trailer with a gradual transition to darkness, which operators may find easier on their vision.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

1. A dock light assembly for illuminating a trailer interior, the light assembly comprising:
a main housing comprising a forward end and an opposing rear end;
a lens holder coupled to the forward end of the housing;
an optical lens secured by the lens holder and configured to provide focused illumination to the trailer interior;
an electronics package secured to a rear portion of the main housing, the electronics package including an illumination source; and
a rotationally self-correcting screen device positioned between the illumination source and the optical lens, the screen device configured to absorb a portion of the focused illumination such that illumination to an upper portion of the trailer interior is reduced.

2. The dock light assembly according to claim 1, wherein the screen device comprises a dense, thin plate having an approximate semi-circular shape, the rotationally self-correcting feature characterized by the plate being free to rotate about a center post, the post being secured to the main housing such that rotational movement of the housing rotates the post but not the plate.

3. The dock light assembly according to claim 2, wherein an upper portion of the plate defines a substantially horizontal plane.

4. The dock light assembly according to claim 1, wherein the optical lens is plano-convex.

5. The dock light assembly according to claim 1, wherein the optical lens comprises a condenser lens coupled with a polyellipsoidal reflector.

6. The dock light assembly according to claim 1, wherein the illumination source is an LED array.

7. The dock light assembly according to claim 1, further comprising a heat sink in thermal contact with the electronics package, the heat sink configured to dissipate heat generated from the light source during operation.

8. The dock light assembly according to claim 7, wherein the heat sink comprises a plurality of thin, radially-extending fins sized for an interference fit within the main housing.

9. The dock light assembly according to claim 1, wherein the screen device comprises a sealed volume defining a reservoir, the rotationally self-correcting feature characterized by the reservoir being filled to a horizontal level with an opaque fluid, such that rotational movement of the housing does not alter the horizontal level of the fluid.

10. The dock light assembly according to claim 9, wherein the screen device comprises a ring having a sealed reservoir therein.

11. The dock light assembly according to claim 10, wherein the ring comprises a forward face and a rear face, each hermetically sealed with an optically clear material.

12. The dock light assembly according to claim 9, wherein the opaque fluid comprises a mixture having a dark fluid in suspension with a lighter fluid.

13. The dock light assembly according to claim 9, wherein the opaque fluid comprises a mixture having a graduated opacity.

14. The dock light assembly according to claim 13, wherein the graduated opacity is denser at the bottom of the reservoir.
